(19) United States
(12) Patent Application Publication
(10) Pub. No.: US 2004/0001703 A1
(43) Pub. Date: Jan. 1, 2004

(54) Video reproduction device having graphic on-screen display (OSD) capabilities and a method for using the same

(76) Inventor: Eun-Jung Kang, Suwon-City (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/458,365

(22) Filed: Jun. 11, 2003

(30) Foreign Application Priority Data
Jun. 26, 2002 (KR) 2002-36057

(51) Int. Cl. H04N 5/781

(52) U.S. Cl. 386/95; 386/125

(57) ABSTRACT

A video reproduction device and method for using the same. The video reproduction device includes a reproduction part for reading out compressed video data recorded in a recording medium, an OSD menu part for storing and outputting compressed graphic data for configuring an OSD menu display, and a controller for selecting and displaying either the compressed video data or the compressed graphic data. Accordingly, the users' ability to recognize items on the OSD is increased, and the operation of the video reproduction device is made more convenient.

This application claims benefit under 35 U.S.C. § 119 from Korean Patent Application No. 2002-36057, filed on Jun. 26, 2002, the entire content of which is incorporated herein by reference.

### BACKGROUND OF THE INVENTION

1. Field of the Invention

The present invention relates to a video reproduction device, and more particularly, to a video reproduction device having graphic On-Screen Display (OSD) capabilities.

2. Description of the Related Art

In recent years, combination devices that employ multiple devices, each having independent functions, into one device have been appearing in the market. Such combination devices have an advantage that they can consolidate components that perform common functions for the sake of convenience and thus allow for a much more efficient use of space than when individual devices are separately used.

The combination devices are typically referred to as a ‘combination system’ or a ‘combo-system’, and a typical example of such combination system may be a (Digital Video Disk/Video Cassette Recorder (DVDP/VCR) combination system which is a multi-video reproduction device implemented in one system having DVD player and VCR functions.

FIG. 1 is a view for schematically showing such a DVDP/VCR combination system and peripheral devices coupled thereto. A DVDP/VCR combination system 100 includes a DVD device 102 for performing the DVD player functions for reproducing images and sounds recorded on a DVD, and a VCR device 104 for performing the functions for reproducing images and sounds recorded on a magnetic tape and the VCR functions for recording an external signal on the magnetic tape.

The DVDP/VCR combination system 100 can be coupled to a display device such as a TV set 140 or the like as a peripheral device for outputting images and sounds reproduced from the internal DVD device 102 or VCR device 104, as well as to an audio amplifier 130 or the like as a peripheral device for outputting sounds reproduced from the DVD device 102 of better quality. Further, an external device 150 such as a camcorder and the like can be coupled to the DVDP/VCR combination system 100, and the DVDP/VCR combo-system 100 can input images and sounds from such an external device 150 to perform the functions of recording, reproducing, and the like.

In addition, the DVD device 102 and the VCR device 104 in the DVDP/VCR combination system 100 have the appearance of existing in a single device. A user can manipulate a separate input device such as a remote controller 120 and the like, a key input part (not shown) provided on the front of the DVDP/VCR combination system 100, or the like, to switch an operation mode between the DVD device 102 and the VCR device 104, and can also manipulate individual functions for each of the DVD device 102 and the VCR device 104.

In the meantime, the combination system 100 as described above generally has an OSD block (not shown) for providing a user with menu items which the user can use to provide input to the system 100 through an OSD function. If a user selects the OSD function in order to input an operation command through the manipulations of the remote controller 120 or the like, menu items that can be viewed and selected by the user are displayed on the screen of the TV set 140 or the like. The user can easily control operations he or she intends to manipulate through such menu items. Such menu items include commands relating to the environment of the DVD device 102 or the VCR device 104, in addition to the general operations of the DVD device 102 or the VCR device 104 such as record/reproduction, stop, fast forward, rewind, and so on.

FIG. 2 is an illustrative view for showing an OSD used in a conventional DVDP/VCR combination system.

Referring to FIG. 2, menu items of ‘initial settings’, ‘screen display language’, ‘disc menu language’, ‘voice language’, ‘caption language’, ‘lock device’, ‘audio settings’, and ‘screen settings’ are displayed on the OSD. Further, buttons are displayed on the lower portion of the OSD to be used when a user views the OSD and inputs operation commands. That is, the user uses the buttons ‘movement:▴▾’ when moving around the respective menu items, the button ‘selection: input’ when selecting a menu item and inputting a command, and the button ‘end: return’ when ending an operation command setting and returning to a previous display. Such buttons are provided on the remote controller 120 or the like.

In addition, the item ‘initial settings’ is for initializing settings such as date/time record, DVD connection selection, and so on. The item ‘screen display language’ is for setting a language to be displayed on the screen of the DVD player, and the item ‘disc menu language’ is for setting a menu language stored in the DVD. Furthermore, the item ‘voice language’ is for setting a voice language to be output from speakers, the item ‘caption language’ is for setting a caption language appearing on the screen of the TV set 140 or the like, and the item ‘lock device’ is for preventing children from watching TV by rating violent programs, erotic programs, and so on. Also, the item ‘screen settings’ is for setting the states and screen of the TV set 140 connected to the DVDP/VCR combination system 100. If such menu items are selected, the sub-menu items of those menu items are displayed.

However, the conventional DVDP/VCR combination system 100 uses and displays only low-resolution character data on the OSD. This means that the character data for configuring the OSD menu is formed in advance in a font data fashion, and displaying menu items of respective menu displays by using the formed character data limits the use of characters and deteriorates the resolution as compared to DVD video data. Furthermore, the use of the restricted fonts makes it impossible to construct menus in diverse fashions.

Accordingly, a user cannot readily use a graphic user interface (GUI) environments in the DVDP/VCR combination system 100. Furthermore, it is difficult to display respective menu items by using complicated characters on an OSD, and a user may find it difficult to understand the meanings of the respective menu items. In addition, an OSD configured in low-resolution character data can deteriorate the entire quality of the product.

### SUMMARY OF THE INVENTION

The present invention has been devised to solve the above and other problems. It is therefore an object of the present invention to provide a video reproduction device having an OSD that is easy and convenient for users to recognize and use by implementing the OSD in a high-resolution graphic display.

In order to substantially achieve the above and other objects, a video reproduction device according to an embodiment of the present invention comprises a reproduction component for reading out compressed video data stored in a recording medium, an OSD menu component for storing and outputting compressed graphic data in order to configure an OSD menu display, and a controller for selecting and displaying either the compressed video data or the compressed graphic data, or both.

The controller preferably includes a selection component for selectively outputting either the inputted compressed video data or the inputted compressed video data, a decoder part for decoding the compressed data outputted from the selection part, and a selection control component for controlling outputs of the selection part.

The compressed graphic data is preferably compressed and stored in a screen unit to configure one OSD menu display, and the compressed graphic data is preferably compressed in the same format as the compressed video data recorded in the recording medium.

The OSD menu component preferably outputs graphic data for configuring different displays based on a control input of a user, and the OSD menu component is preferably constructed in a different medium from the recording medium. Furthermore, the OSD menu component can be constructed with a semiconductor memory.

### BRIEF DESCRIPTION OF THE DRAWINGS

The above objects and other features of the present invention will become more apparent by describing in detail certain embodiments thereof with reference to the attached drawings, in which:

FIG. 1 is a block diagram schematically showing a general DVDP/VCR combination system;

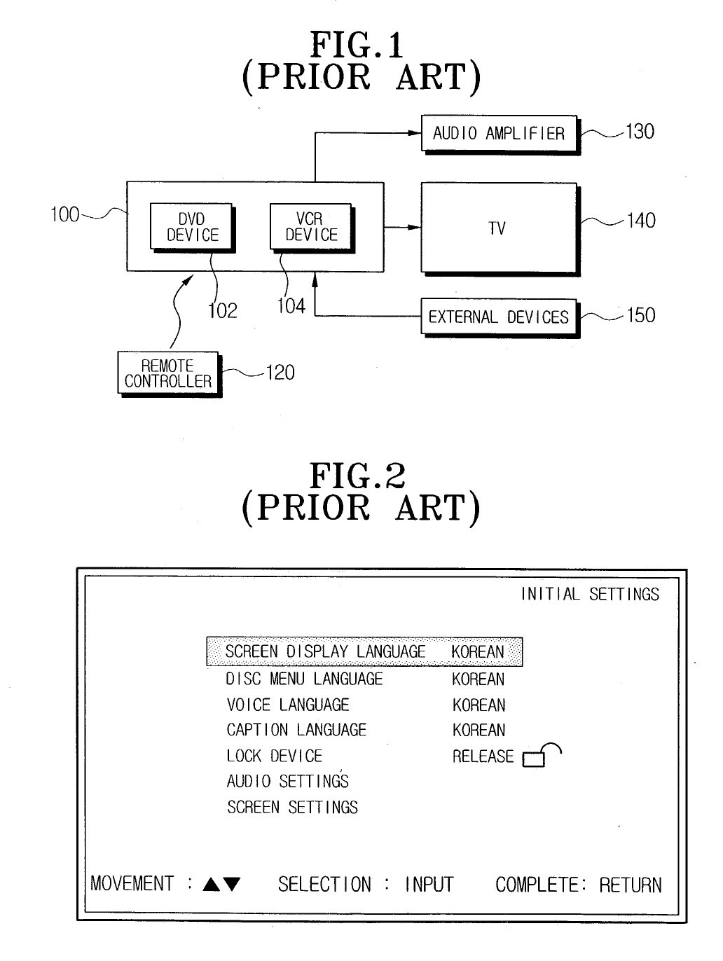

FIG. 2 is a view for showing an example of a conventional OSD;

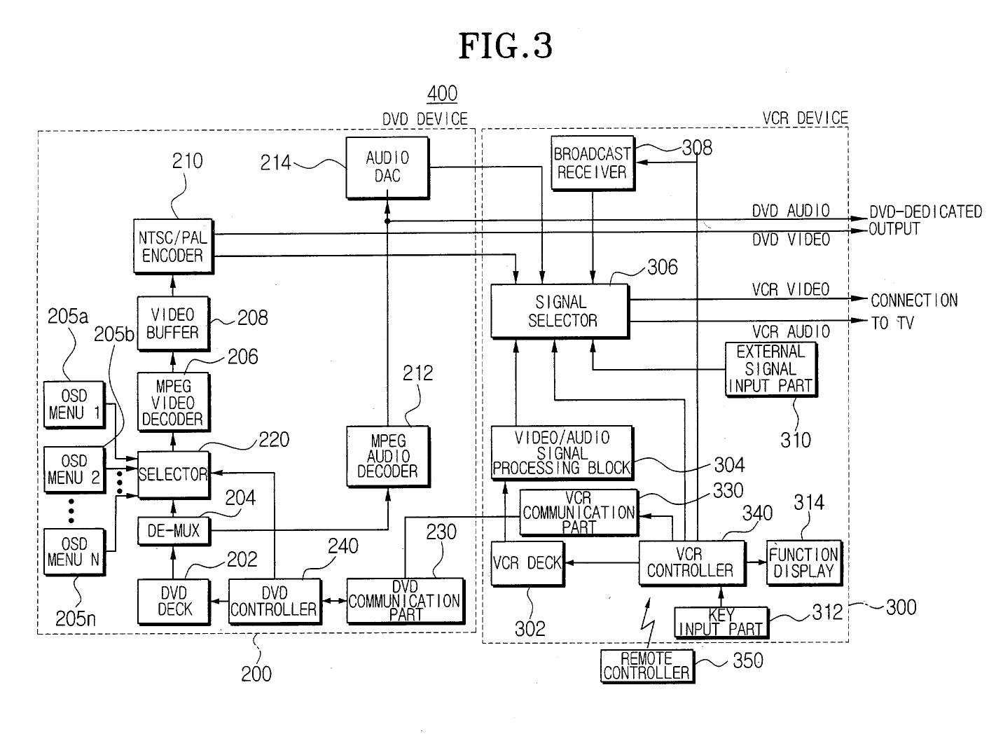

FIG. 3 is a block diagram for showing a video reproduction device having an OSD according to an embodiment of the present invention; and

FIG. 4 to FIG. 6 are illustrative views for showing OSDs according to an embodiment of the present invention.

### DETAILED DESCRIPTION OF THE PREFERRED EMBODIMENTS

Hereinafter, certain embodiment of the present invention will be described in detail with reference to the drawings.

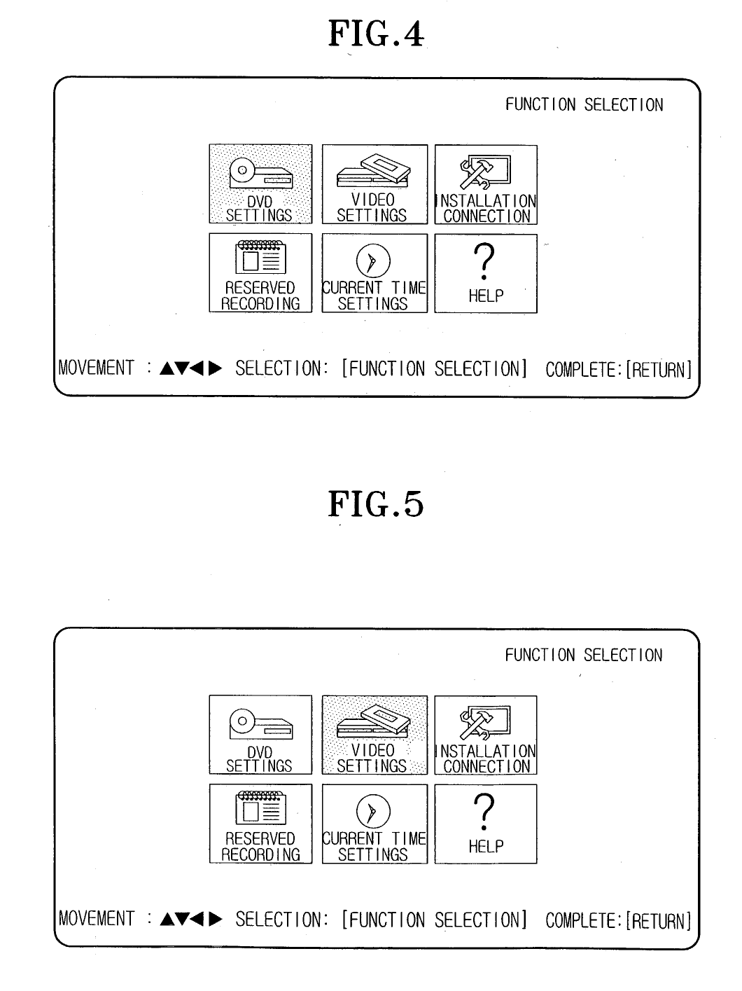

FIG. 3 is a block diagram showing an internal structure of a video reproduction device, in particular, a DVDP/VCR combination system 400 capable of performing the functions of a DVD player and a VCR according to an embodiment of the present invention.

The DVDP/VCR combination system 400 is constructed with a DVD device 200 that performs the functions of a general DVD player, and a VCR device 300 that performs the function of a general VCR device.

The DVD device 200 includes a DVD deck 202, DE-MUX 204, OSD menu 1 component consisting of OSD menu 1˜OSD menu n 205a to 205n, MPEG video decoder 206, VIDEO buffer 208, NTSC/PAL encoder 210, MPEG audio decoder 212, audio DAC 214, selector 220, DVD communication component 230, and DVD controller 240.

The DVD deck 202 operates to read in data recorded in a DVD in order to perform a reproduction operation for the DVD. The DE-MUX 204 classifies the data read in from the DVD deck 202 into a Moving Picture Experts Group(MPEG) video signal and an MPEG audio signal, and transfers the MPEG video signal to the selector 220 and the MPEG audio decoder 212.

Graphic data for showing OSDs in graphics is MPEG-encoded and stored on the OSD menu 1 to OSD menu n 205a to 205n consisting of the OSD menu component. In this example, the MPEG-encoded and stored graphic data is configured with one data group for every OSD, and stored in any one of the respective OSD menu 1 to OSD menu n 205a to 205n. MPEG-encoding and storing of graphic data for OSD configurations is performed because much data is required to show OSD graphics and compressing data is necessary to effectively store much data in a limited storage device.

The selector 220 selectively outputs and transfers to the MPEG video decoder 206 any one of the output signals of the OSD menu 1 to OSD menu n 205a to 205n and the DE-MUX 204. The DVD controller 200 controls which signal the selector 220 selects and outputs. That is, the DVD controller 200 functions as a selection controller for controlling the outputs of the selector 220.

The MPEG video decoder 206 decodes the MPEG-encoded data output from the selector 220, and the MPEG audio decoder 212 decodes an MPEG-encoded audio signal. The VIDEO buffer 208 functions as a buffer temporarily storing a decoded video signal.

The NTSC/PAL encoder 210 outputs a DVD video signal in the national television system committee (NTSC) mode or in the phase alternation line (PAL) mode by using data stored in the VIDEO buffer 208, and the audio DAC 214 receives data from the MPEG audio decoder 212 and outputs a DVD audio signal. The DVD video signal of the NTSC/PAL encoder 210 and the DVD audio signal output from the audio DAC 214 are employed for DVD-dedicated output signals. The DVD-dedicated output signal is coupled to the output ports for Y, Pr, and Pb component outputs, S-video outputs, digital audio outputs, and so on, in order for a user to use better-quality video and audio signals.

The MPEG video decoder 206, VIDEO buffer 228, NTSC/PAL encoder 210, and so on, make up a display component that restores and displays on a TV set or the like data that the selector 220 selectively outputs.

The DVD controller 240 controls the overall operations of the individual constituents in the DVD device 200 in addition to the selection of the selector 220, and the DVD communication part 230 is used for communication between the DVD device 200 and the VCR device 300.

The VCR device 300 includes a VCR deck 302, video/audio signal processing block 304, signal selector 306, broadcast receiver 308, external signal input part 310, key input part 312, FUNCTION display 314, VCR communication part 330, and VCR controller 340.

The VCR deck 302 records a signal on a magnetic tape or reproduces a signal recorded on the magnetic tape, and the video/audio signal processing block 304 receives and transfers video and audio signals to be recorded or reproduced to and from the VCR deck 302.

The signal selector 306 selects a signal to be connected to a TV set or the like from an output of the NTSC/PAL encoder 210, an output of the audio DAC 214, an output of the video/audio signal processing block 304, signals from the broadcast receiver 308 and the external signal input part 310, and so on, based on the control of the VCR controller 340. The signal becomes VCR video and audio signals.

The broadcast receiver 308 tunes to a broadcast channel for a TV set or the like to receive a desired broadcast channel, and the external signal input part 310 has a function transferring an output signal of an external device such as a camcorder or the like to the signal selector 306.

The FUNCTION display 314 shows information such as operation states, operation modes, and the like of the DVDP/VCR combination system 400 to external in order for a user to view the information, and various commands of a user are inputted through the key input part 312 and a remote controller 350. The VCR controller 340 receives and performs the control based on operation commands inputted from a user through the key input part 312 and the remote controller 350, and also controls the entire operations of the respective constituents of the VCR device 300.

The VCR controller 340 and the DVD controller 240 are connected to each other through the VCR communication part 330 and the DVD communication part 230 to mutually receive and transfer commands.

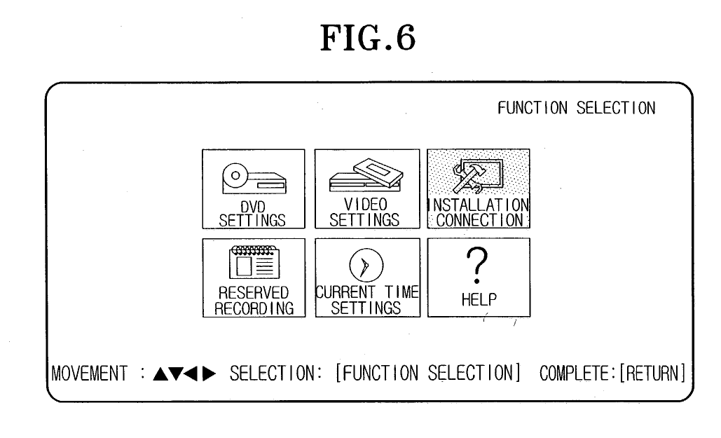

FIG. 4 to FIG. 6 show examples of illustrative OSDs of the video signal reproduction device according to embodiments of the present invention.

As shown in FIGS. 4 to 6, the OSDs are shown in graphics, and menu items of ‘DVD settings’, ‘video settings’, ‘installation connection’, ‘reserved recording’, ‘current time settings’, and ‘help’ are shown in an initial OSD.

Items entitled ‘movement: ▴▾ [symbol] [symbol] ’, ‘selection: [function selection]’, and ‘complete: [return]’ are displayed on the lower portion of the OSD. These indicate buttons are used when a user views the OSD and inputs an operation command. That is, a user uses any one of the ‘movement: ▴▾ [symbol] [symbol] ’ buttons when he or she wants to move to each menu item, a ‘selection: [function selection]’ button when selecting a menu item and a function, and a ‘complete: [return]’ button for the completion of an input of an operation command or for the return to a previous display. Such buttons are provided on the remote controller 350 or the key input part 312.

A user can manipulate up, down, left, and right movement buttons of ‘▴▾ [symbol] [symbol] ’ to move a cursor to one of the menu items shown in an OSD. In the drawings, the dotted menu item indicates a menu item on which a cursor is currently placed. A menu item on which a cursor is currently positioned can be indicated by using a different color distinct from the colors of the other items.

FIG. 4 shows that a cursor is positioned on a ‘DVD settings’ item by a user, FIG. 5 shows that a cursor is placed on a ‘video settings’ item, and FIG. 6 shows that a cursor is positioned on an ‘installation connection’ item.

The OSD graphic data is stored in any one of the respective OSD menu 1 to OSD menu n 250a to 250n in order to configure the respective OSDs shown in FIG. 4 to FIG. 6. For example, the graphic data to construct a display shown in FIG. 4 is stored in the OSD menu 1 250a, the graphic data to configure a display shown in FIG. 5 is stored in the OSD menu 250b, and the graphic data to structure a display shown in FIG. 6 is stored in the OSD menu 3 250c. Although not shown in the drawings, the graphic data for constructing an OSD on which the ‘reserved recording’ item is selected is stored in the OSD menu 4, the graphic data for constructing a display on which the ‘current time settings’ item is selected is stored in the OSD menu 5, and the graphic data for constructing a display on which the ‘help’ item is selected is stored in the OSD menu 6.

In such a state that the graphic data is stored, if a user presses a button set to show an OSD through the remote controller 350 or the key input part 312, the VCR controller 340 receives a signal caused by the button and transfers the signal to the DVD controller 240 through the VCR communication part 330 and the DVD communication part 230. The DVD controller 200 controls the selector 220 to first output the graphic data stored in the OSD menu 1 250, to thereby show an OSD shown in FIG. 4 on the display device of a TV set or the like.

The user manipulates the up, down, left, and right movement buttons of ‘▴▾ [symbol] [symbol] ’ to move the cursor, viewing a shown OSD, and, through the above steps, one of the OSD menu 1 to the OSD menu n 250a to 250n is selected which stores the graphic data to configure a corresponding OSD, so that the corresponding OSD is shown.

The user presses a button of ‘selection/function selection’ to select a menu item on which a cursor is currently placed. The menu item selected by the user is again received in the VCR controller 340, and transferred to the DVD controller 240 through the VCR communication part 330 and the DVD communication part 230. The DVD controller 240 decides for which operation a command of a corresponding command value may be. If a command value is an operation command related to a DVD as a result of the decision, the DVD controller 240 performs an operation based on the corresponding command value. If the transferred command value is not an operation command related to the DVD, the DVD controller 240 transfers the command value to the VCR controller 340 through the DVD communication part 230 and the VCR communication part 330, and the VCR controller 340 performs an operation based on the transferred command value.

In the meantime, it is possible to construct to pop up a new OSD showing sub-items for a corresponding menu item when a user moves a cursor to one of the menu items and presses the button of ‘selection/function selection’.

For example, if a user selects the item of ‘DVD settings’, an OSD appears which shows sub-operation items related to the DVD settings. These include the ‘screen display language’ for setting a screen display language of the DVD display, ‘disc menu language’ for setting a menu language recorded in the DVD, ‘voice, language’ for setting a voice language to be outputted from speakers, ‘caption language’ for setting a caption language, and so on. Further included is the items of ‘lock device’ for limiting program rates, ‘audio settings’ for connected audio settings, ‘screen settings’ for setting a DVD screen related to states of a connected TV set or the like, and so on.

If a user selects the item of ‘video settings’, the items of ‘tape selection’ for selecting the kind of tape to be used, ‘video-dedicated channel selection’ for selecting a video-dedicated channel, ‘iterative reproduction function use’ for enabling repetitive watching from the beginning by automatically rewinding a tape when reproduction is finished and starting the reproduction again upon setting the iterative reproduction, ‘blue screen use’ for using a blue color screen, ‘quality selection’ for selecting a soft screen and so on upon a video reproduction, and so on, are shown.

The item of ‘reserved recording’ is used when a reserved video recording is needed. If a user selects the item of ‘reserved recording’, shown is an OSD having items of ‘channel’ for selecting a broadcast channel to be recorded, ‘recording start time’, ‘recording speed’, and so on.

If a user selects the item of ‘current time settings’, the user can set a current time. The current time is used for the reserved recording and the like, and it is possible to use the current time for a clock by displaying the current time all the time. Further, if a user selects the item of ‘help’, shown is a help window helping the user use an OSD.

In case of configuring the OSDs as stated above, the graphic data configuring the respective OSDs is stored independently in the OSD menu 1 to OSD menu n 205a to 205n respectively, and the selector 220 selects and displays any one of the OSD menu 1 to OSD menu n 205a to 205n. As described above, each menu item displayed in graphic becomes easily recognized in meaning and convenient in use by users.

As described above, in accordance with an embodiment of the present invention, a video reproduction device is provided which shows OSDs in high-resolution graphics, so that users can easily recognize and conveniently use the OSDs. Further, the OSDs processed in high-resolution graphics can contribute to the enhancements of the product quality of the entire system.

Further, although certain embodiments of the present invention have been described, it will be understood by those skilled in the art that the present invention should not be limited to the described embodiments, but various changes and modifications can be made within the spirit and scope of the present invention as defined by the appended claims, and such changes and modifications should not be individually understood from the technical thought and outlook of the present invention.

What is claimed is:

1. A video reproduction device comprising:
a reproduction component, adapted to read out video data stored in a recording medium;
an on-screen display (OSD) menu component, adapted to store and output graphic data in order to configure an OSD menu display; and
a controller, adapted to select and display one of the video data and the graphic data.

2. A video reproduction device as claimed in claim 1, wherein said controller comprises:
a selection component, adapted to selectively outputting one of the inputted video data and the input video data;
a decoder, adapted to decode the data outputted from the selection component; and
a selection control component, adapted to control outputs of the selection component.

3. A video reproduction device as claimed in claim 1, wherein:
said video data recorded in the recording medium is compressed; and
said graphic data is compressed and stored in a screen unit to configure one OSD menu display, and said graphic data is compressed in the same format as the video data recorded in the recording medium.

4. A video reproduction device as claimed in claim 1, wherein:
said OSD menu component is adapted to output said graphic data for configuring different displays based on a control input of a user.

5. A video reproduction device as claimed in claim 1, wherein:
said OSD menu component includes a medium different from the recording medium.

6. A video reproduction device as claimed in claim 1, wherein:
said OSD menu component includes a semiconductor memory.

7. A video reproduction device as claimed in claim 1, wherein:
said video data recorded in the recording medium is compressed.

8. A video reproduction device as claimed in claim 1, wherein:
said graphic data is compressed.

9. A video reproduction device as claimed in claim 1, wherein:
said video data recorded in the recording medium and said graphic data are compressed.

10. A method for operating a video reproduction device, the method comprising:
reading out video data stored in a recording medium;
storing and outputting graphic data in order to configure an OSD menu display; and
selecting and displaying one of the video data and the graphic data.

11. A method as claimed in claim 10, wherein said selecting and displaying comprises:
selectively outputting one of the inputted video data and the input video data; and
decoding the output data.

12. A method as claimed in claim 10, further comprising:
said video data recorded in the recording medium is compressed; and
compressing and storing said graphic data in a screen unit to configure one OSD menu display; and
compressing said graphic data in the same format as the video data recorded in the recording medium.

13. A method as claimed in claim 10, wherein said storing and outputting comprises:
outputting said graphic data for configuring different displays based on a control input of a user.

14. A method as claimed in claim 10, wherein:
said storing and outputting is performed by an OSD menu component including a medium different from the recording medium.

15. A method as claimed in claim 10, wherein:
said storing and outputting is performed by an OSD menu component including a semiconductor memory.

16. A video reproduction device as claimed in claim 10, wherein:
said video data recorded in the recording medium is compressed.

17. A video reproduction device as claimed in claim 10, wherein:
said graphic data is compressed.

18. A video reproduction device as claimed in claim 10, wherein:
said video data recorded in the recording medium and said graphic data are compressed.
